(19) United States
(12) Patent Application Publication
(10) Pub. No.: US 2026/0055750 A1
(43) Pub. Date: Feb. 26, 2026

(54) INTERNAL COMBUSTION ENGINE

(71) Applicant: INNIO Jenbacher GmbH & Co OG, Jenbach (AT)

(72) Inventors: Wolfgang Fimml, Maurach in Tirol (AT); Michael Url, Neufahrn (DE); Clement Leroux, Jenbach (AT)

(21) Appl. No.: 19/287,733

(22) Filed: Jul. 31, 2025

(30) Foreign Application Priority Data
Aug. 20, 2024 (EP) EP24195420

(51) Int. Cl. F02M 26/20; F02M 21/02; F02M 26/04; F02M 26/14

(52) U.S. Cl. CPC F02M 26/20; F02M 21/0206; F02M 26/04; F02M 26/14

(57) ABSTRACT

An internal combustion engine includes at least three piston-cylinder-units for combusting an air-fuel mixture, wherein each piston-cylinder-unit comprises an intake port and an exhaust port. The engine further includes an intake system fluidically connected to each intake port of the at least three piston-cylinder-units for providing air or air-fuel mixture. The engine further includes an exhaust system for discharging exhaust gases of the combustion. The exhaust ports of at least two piston-cylinder-units are fluidically connected to the intake system to recirculate an exhaust gas into the combustion of the at least three piston-cylinder-units and the exhaust system is configured to entirely discharge exhaust gas from one or more remaining piston cylinder-units of the at least three piston-cylinder-units.

### CROSS-REFERENCE TO RELATED APPLICATION

This application claims priority to and benefit of EP Application No. EP24195420.5, filed on Aug. 20, 2024, entitled “INTERNAL COMBUSTION ENGINE”, which is herein incorporated by reference in its entirety.

### BACKGROUND

The present disclosure relates to an internal combustion engine.

Internal combustion engines include:
at least three piston-cylinder-units for combusting an air-fuel mixture, wherein each piston-cylinder-unit includes an intake port and an exhaust port,
an intake system fluidically connected to each intake port of the at least three piston-cylinder-units for providing air or air-fuel mixture, and
an exhaust system for discharging exhaust gases of the combustion.

Exhaust gas recirculation (EGR-) systems are used to reduce emissions of internal combustion engines, in particular nitrogen oxide emissions (NOx).

Nitrogen oxide emissions are in greater quantities with higher combustion peak temperatures, especially at temperatures above 2300° K.

A way to reduce the nitrogen oxide emissions is to supply exhaust gases to the air or air-fuel-mixture provided for combustion, wherein the recirculated exhaust gas amount increases specific heat capacity of the mixture in the combustion chamber, which lowers the combustion peak temperature and reduces the formed amount of nitrogen oxide emissions.

If the exhaust gas of the combustion engine is fed back to the combustion engine outside of the combustion chamber, this is called an external exhaust gas recirculation system.

Therefore, engines—especially internal combustion engines including a turbocharger unit—may provide an exhaust gas recirculation line in the exhaust system downstream of the turbine of the turbocharger to refeed exhaust gas into the intake system upstream of the compressor of the turbocharger.

As the current trend of the state of the art tends to use more and more carbon neutral fuels also the commonly known ways for reduction of NOx could be used, e.g., using an EGR-system at an internal combustion engine combustion hydrogen.

But a combustion of hydrogen together with a different fuel or pure hydrogen leads to much higher exhaust gas recirculation rates, in some estimates EGR-rates up to 40-50%.

As it can be seen, in such embodiments, high mass flows of exhaust gas back into the combustion process have to be handled, wherein the whole exhaust system has to be adapted to deal with such high mass flows.

Therefore, the components of the exhaust system and the EGR-system have to be provided correspondingly large.

Therefore, there is a wish for a smaller, resources saving and/or simpler possibility for providing an EGR-system of an internal combustion engine.

### BRIEF DESCRIPTION

An aspect of the present disclosure is therefore to provide an internal combustion engine which at least partly improves upon the mentioned negative effects compared to the prior art and/or provide a simpler possibility for providing an EGR-system and/or provide a smaller or more compact possibility of an EGR-system and/or to a possibility to improve the overall efficiency and economic aspect of an internal combustion engines and/or reduce efforts which are related with EGR-systems.

This aspect is achieved with an internal combustion engine with the features described in detail below.

According to aspects of the present disclosure, an internal combustion engine includes:
at least three piston-cylinder-units for combusting an air-fuel mixture, wherein each piston-cylinder-unit includes an intake port and an exhaust port,
an intake system fluidically connected to each intake port of the at least three piston-cylinder-units for providing air or air-fuel mixture, and
an exhaust system for discharging exhaust gases of the combustion
   wherein the exhaust ports of at least two piston-cylinder-units are fluidically connected to the intake system to recirculate an exhaust gas into the combustion of the at least three piston-cylinder-units and the exhaust system is configured to entirely discharge exhaust gas from the remaining piston cylinder-unit(s) of the at least three piston-cylinder-units.

According to aspects of the present disclosure, the exhaust gas recirculation system is provided only for a part of the piston-cylinder-units. In this way, the advantages of exhaust gas recirculation can be exploited with a relatively small footprint of a small exhaust gas recirculation system

By use of the mass flow of exhaust gas of at least two piston-cylinder units in a simply and efficient way exhaust gas can be “pumped” back into the intake system.

Therefore, the exhaust gas mass flow already existing having a relatively high pressure and/or flow rate provided within the exhaust stroke can effectively be used to pass the exhaust gases into the intake system.

Furthermore, by passing the exhaust gases of at least two piston-cylinder units into the intake system, the exhaust system for the remaining piston cylinder-unit(s) can be dimensioned much smaller, as exhaust gases of at least two piston-cylinder units do not have to be transported or aftertreated.

Also, the intake system can be dimensioned smaller in contrast to the state of the art, as the exhaust gas can be fed with high pressure into the intake system in a flow direction of the intake system near to the piston-cylinder units, wherein the exhaust gas does not have to be led—as known by the state of the art—long ways through the intake system and also does not have to be, e.g., compressed by a turbocharger.

If a turbocharger is provided, the turbocharger can be dimensioned much smaller compared to the state of the art.

In summary, by use of an embodiment of the present disclosure, a much smaller assembly space is needed, as components can be saved or downsized, nevertheless having the same delivery to the piston-cylinder units.

The feedback according the first embodiment can be compared to an EGR-pump, wherein the at least two piston-cylinder units are provided as EGR-pump without the use of a separate component.

Already present internal combustion engines can be upgraded and operated with a gas mixer according to the present disclosure. Therefore, the present disclosure can be used for the embodiments of the prior art already described in the introduction of the description.

The present disclosure can particularly preferably be used in conjunction with an internal combustion engine driving a generator for creating electrical energy. Such combinations of internal combustion engines driving a generator are known as gensets.

The “remaining piston-cylinder-unit(s)” according to this disclosure are those piston-cylinder-units of which the exhaust gases are discharged entirely. In other words, the exhaust system is configured to discharge the exhaust gases of the remaining piston-cylinder-units entirely, while the exhaust gases of the other piston-cylinder-units are recirculated by virtue of the fluid connection between the respective exhaust ports and the intake system.

Advantageous embodiments are defined in the dependent claims.

It can be provided, that the internal combustion engine includes at least two cylinder banks, wherein the exhaust ports of all piston-cylinder-units of one cylinder bank are fluidically connected to the intake system.

Preferably, the exhaust gases of the other cylinder bank or cylinder banks are discharged entirely.

It can be provided that the exhaust ports of the piston-cylinder-units of each cylinder bank are connected to an exhaust manifold, wherein in each exhaust manifold the exhaust gases of the respective cylinder bank of the corresponding piston-cylinder-units are merged.

It can be provided that one of the exhaust manifolds of the cylinder banks is fluidically connected to the intake system, preferably to feed an entire exhaust gas of one cylinder bank to the intake system.

It can be provided that internal combustion engine includes, preferably exactly, two cylinder banks, wherein each cylinder bank includes one exhaust manifold which merges the exhaust gas of all piston-cylinder units associating with the respective cylinder bank, wherein one of this two exhaust manifolds are directly fluidically connected, preferably via the exhaust recirculation line, with the intake system, particularly preferred wherein the whole exhaust gas of one of the two cylinder banks is fed via the exhaust recirculation line.

It can be provided that the fluid connection between the exhaust ports and the intake system is provided by an exhaust gas recirculation line.

It can be provided that the exhaust gas recirculation line is designed in such a way that the entire exhaust gas of the exhaust ports of at least two piston-cylinder-units is guided though exhaust gas recirculation line, preferably and can be fed into the intake system to recirculate an exhaust gas into the combustion of the at least three piston-cylinder-units.

It can be provided that an exhaust gas recirculation valve is provided, preferably at the exhaust gas recirculation line, wherein by controlling the exhaust gas recirculation valve an amount of exhaust gas fed into the intake system can be controlled.

At least one control unit can be provided for controlling the exhaust gas recirculation valve. The at least one control unit can be provided, e.g., by the central machine control unit (e.g., controller) of the internal combustion engine or can be provided as separate unit.

It can be provided that at least one fuel injector, preferably a hydrogen injector, is provided at the exhaust gas recirculation line, wherein the exhaust gas fed back into the intake system can be enriched by use of the fuel injector with fuel, preferably hydrogen.

By injecting fuel for the combustion into the exhaust gas recirculation line especially fuel having a high flammability (e.g., hydrogen) can be fed into the intake system in a relatively stable way, as the enriched exhaust gas does not have a flammability (as the exhaust gas does not have or only a relatively low amount of oxygen), wherein the risk of an unintentional combustion in the intake system can be reduced.

It can be provided that by controlling of the exhaust gas recirculation valve a mass flow of exhaust gas back into the combustion via the intake system can be controlled and therefore the exhaust gas recirculation rate can be controlled.

A connecting line can be provided, wherein by use of the exhaust gas recirculation valve a surplus amount of exhaust gas can be fed via the connecting line into an exhaust line of the exhaust system of the remaining piston cylinder-unit(s) of the at least three piston-cylinder-units.

It can be provided that a connecting line is fluidically connecting the exhaust gas recirculation valve and/or the exhaust gas recirculation line with an exhaust line of the exhaust ports of the remaining piston cylinder-unit(s) of the at least three piston-cylinder-units.

It can be provided that the intake system includes one central intake manifold fluidically connected via the intake ports to all piston-cylinder-units.

The internal combustion engine can be provided as a V-engine.

It can be provided that the intake system includes an EGR-mixer for mixing air or air-fuel mixture with the recirculated exhaust gas.

It can be provided that the exhaust ports of the remaining piston-cylinder-unit(s) of the at least three piston-cylinder-units are fluidically connected via an exhaust line to a turbine, preferably the turbine being part of a turbocharger unit.

It can be provided that the intake system includes a compressor, preferably the compressor being part of a turbocharger unit, for charging air or air-fuel mixture being fed to the piston-cylinder-units.

It can be provided that the intake system includes at least one intercooler, preferably arranged in flow direction of the air or air-fuel mixture downstream of the compressor and/or upstream of the mouth of the exhaust gas recirculation line into the intake system.

It can be provided that, in a flow direction of the air or air-fuel mixture, the compressor is arranged upstream of the fluid connection of the at least two exhaust ports to the intake system.

It can preferably be provided that the exhaust gas recirculation is provided by a high pressure exhaust gas recirculation system.

In high pressure exhaust gas recirculation systems, the exhaust gas is taken from the exhaust system upstream of an exhaust gas turbine of a turbo charger (where there is a relatively high pressure) and fed into the intake system downstream of the compressor of the turbo charger (where there is also a relatively high pressure).

The present disclosure can of course in principle also be applied to low pressure exhaust gas recirculation systems or mixed embodiments.

It can be provided that at least one fuel injector is arranged in each of the piston-cylinder-units, wherein an air-fuel mixture in the combustion chambers is provided by supplying air via the intake system and a fuel, preferably hydrogen, via the fuel injectors.

It can be provided that the internal combustion engine is a stationary internal combustion engine, preferably including a generator for generating electricity and the internal combustion engine is configured to drive the generator.

### BRIEF DESCRIPTION OF THE DRAWINGS

Further details and advantages of the present disclosure are apparent from the accompanying figures and the following description of the drawings. The figures show:

FIG. 1 illustrates an embodiment of an internal combustion engine,

FIG. 2 illustrates an embodiment of an internal combustion engine according to the present disclosure, and

FIG. 3 illustrates an embodiment of an internal combustion engine according to the present disclosure, and

FIG. 4 illustrates an embodiment of an internal combustion engine according to the present disclosure.

### DETAILED DESCRIPTION

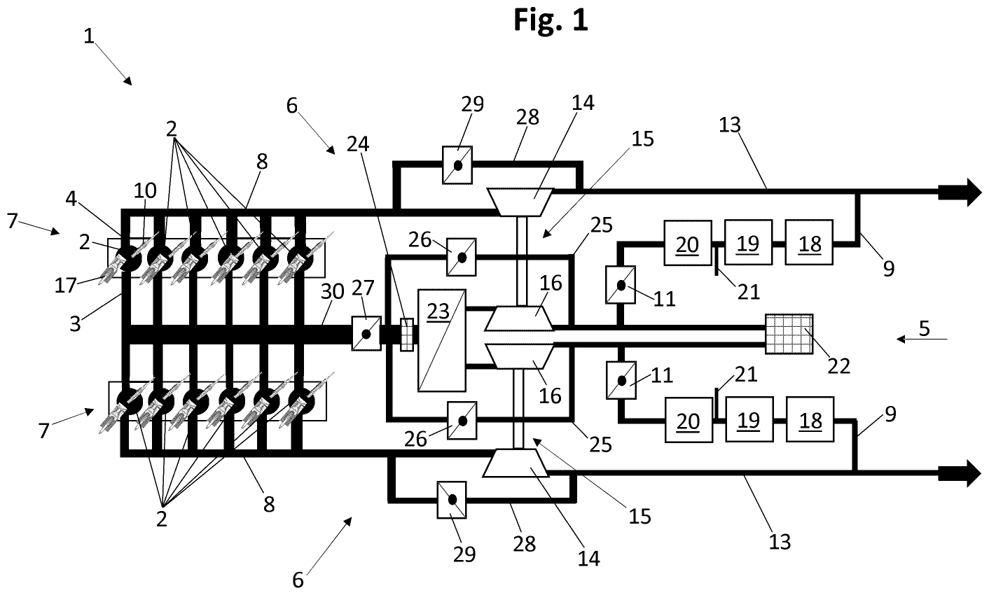

FIG. 1 illustrates an embodiment of an internal combustion engine 1, including two cylinder banks 7.

This internal combustion engine 1 is designed as a V-engine.

Each of the cylinder banks 7 includes six piston-cylinder units 2 providing combustion chambers in which an air-fuel mixture is combusted.

The present disclosure is not restricted to a V-engine or twelve cylinder-piston units 2, and the Figures serve only as an example. The present disclosure can be used on an internal combustion engine 1 for one or more cylinder-piston units 2.

All piston-cylinder units 2 include an intake port 3, an exhaust port 4, a pre-chamber 17 and a fuel injector 10. These components are only identified by reference signs at one of the piston-cylinder units 2 to provide a higher clarity regarding the visualization.

The piston-cylinder units 2 are centrally supplied via the intake system 5 by a compressed air.

The air is sucked by the compressors 16 of the turbocharger units 15 via the air filter 22 from the environment of the internal combustion engine 1 into the intake system 5.

After passing the air filter 22, the air is split into two feeding lines of the compressors 16, as the internal combustion engines 1 disclosed in FIG. 1 includes two turbocharger units 15 to deliver a needed air volume for the combustion inside the piston-cylinder units 2.

The compressors 16 are driven by the exhaust turbines 14 of the turbocharger unit 15, wherein at each turbocharger unit 15 the compressor 14 is mechanically coupled to the compressor 16.

After being compressed, the charged air is fed into the intercooler 23, wherein the hot charged air delivered by the two compressors 16 is merged into the central intake manifold 30 and is being cooled.

Next to the intercooler 23, the charged cooled air is passed via a drainage filter 24, wherein droplets build in the compressed air during cooling inside the intercooler 23 can be removed from the compressed air.

The intercooler 23 and the compressors 16 can be bypassed by intake bypass lines 25 with compressor bypass valves 26, wherein a boost pressure can be adjusted by the compressor bypass valves 26 and with that boost pressure the piston-cylinder units 2 can be filled.

By changing the boost pressure, it is possible to vary the filling of piston-cylinder units 2.

Furthermore, the intake system 5 includes a throttle valve 27, wherein an air mass supplied to the piston-cylinder units 2 can be controlled by the opening degree of the throttle valve 27.

In this specific embodiment of FIG. 1, the air for forming the air-fuel mixture is supplied via the intake system 5 and the fuel—preferably hydrogen—is supplied via fuel injectors 10 (e.g., port injection valves) provided for each cylinder-piston unit 2.

The air-fuel mixture is therefore provided in the cylinder-piston units 2 by mixing a separately supplied fuel—the fuel supplied by the fuel injectors 10 directly into the cylinder-piston units 2—and the charged air supplied via the intake system 5 inside the combustion chambers (wherein the combustion chambers are provided by the cylinder-piston units 2).

Alternatively, it can also be provided that the air-fuel mixture supplied can be mixed by a gas mixer (not illustrated in FIG. 1) upstream of the compressors 16, wherein a fuel or a fuel mixture—e.g., provided by a hydrogen supply grid—can be mixed with air and passed to the compressor 16.

Furthermore, each of the piston-cylinder units 2 include an ignition amplifier provided by a pre-chamber unit 17. Each of the pre-chamber units 17 is provided with a spark plug, wherein the pre-chamber units 17 can separately be supplied with an air-fuel mixture or can be supplied with an air-fuel mixture via the combustion chambers of the piston-cylinder units.

An exhaust system 4 being connected to each cylinder-piston unit 2 is provided for discharging an exhaust gas from the cylinder-piston units 2 after combustion.

Exactly speaking, in this embodiment of an internal combustion engine 1, two separate exhaust trains of the exhaust system 6 are provided for each of the cylinder banks 7 having the same components.

Each of the two cylinder banks 7 include an exhaust system 6, wherein all exhaust ports 4 of all piston-cylinder units 2 corresponding to one cylinder bank 7 are merged in a exhaust manifold 8.

Therefore, two exhaust manifolds 8 are provided, wherein each exhaust manifold 8 associates to one of the cylinder banks 7.

In addition, the turbochargers 15 in each exhaust train include an exhaust turbine 14 being arranged at the exhaust system 6.

Each turbine 14 can be bypassed by an exhaust bypass line 28 along with the turbine bypass valve 29.

By means of this turbine bypass valve 29, an exhaust backpressure can be set which acts on the combustion chambers of the piston-cylinder units 2.

Furthermore, each exhaust train includes an exhaust gas recirculation line 9 being fluidically connected to the exhaust system 6 and the intake system 5 and is provided to branch off a part of the exhaust gas of the exhaust system 6 and feed this exhaust gas into the intake system 5.

The exhaust gas recirculation lines 9 branch off downstream of the exhaust turbines 14 and the exhaust bypass lines 28 from the exhaust lines 13 of the exhaust system 6.

Each of the exhaust gas recirculation lines 9 includes a first exhaust cooler 18, a second exhaust cooler 19 and a third exhaust cooler 20, which include heat exchangers for cooling the exhaust gas. These exhaust coolers 18, 19, 20 are used to cool down the exhaust gases before being mixed with the fresh air sucked via the air filter 22 to avoid the condensation of droplets inside the intake system 5 (which droplets could damage or effect the function of the compressors 16).

Furthermore, the exhaust gas recirculation lines 9 each are provided with drainage lines 21, wherein condensate buildup during cooling down the exhaust gas by the exhaust coolers 18, 19, 20 can be led out from the system.

By use of the exhaust gas recirculation valve 11, a mass of exhaust gas passed into the intake system 5 can be controlled and therefore an exhaust gas recirculation rate can be adjusted.

Such a system is commonly used for the combustion of hydrogen, as the combustion of hydrogen makes it necessary to deliver high air volumes and, if an exhaust gas recirculation system is used, also to deliver high volumes of exhaust gas. Exhaust gas recirculation rates up to 50-60% are commonly known for combustion processes of hydrogen.

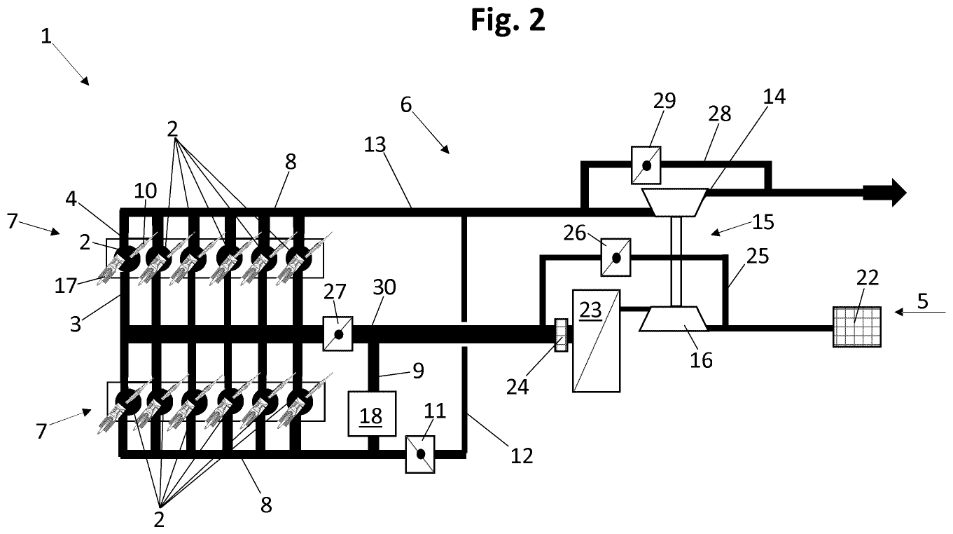

FIG. 2 discloses an embodiment of an internal combustion engine 1, wherein, in contrast to the state of the art, the exhaust ports 4 of at least two piston-cylinder-units 2 are directly fluidically connected to the intake system 5 to recirculate an exhaust gas into the combustion of the at least three piston-cylinder-units 2 and the exhaust system 6 is configured to entirely discharge exhaust gas from the remaining piston cylinder-units 2.

The intake system 5 includes one central intake manifold 30 fluidically connected via the intake ports 3 to all piston-cylinder-units 2.

As can be seen, in the embodiment of FIG. 2, the exhaust manifold 8 of one of the two cylinder banks 7 is fluidically coupled by the exhaust gas recirculation line 9 with the intake system 5, wherein the exhaust gas recirculation line 9 branches into the intake system 5 at a high pressure side, wherein the entire exhaust gas of one cylinder bank 7 can be fed to the intake system 5.

The exhaust gas recirculation line 9 is provided with an exhaust gas cooler 18 for cooling the exhaust gas supplied into the intake manifold 30.

Furthermore, an exhaust gas recirculation valve 11 is provided, wherein by controlling the exhaust gas recirculation valve 11 an amount of exhaust gas fed into the intake system 5 can be controlled.

A connecting line 12 is provided, wherein by use of the exhaust gas recirculation valve 11 a surplus amount of exhaust gas can be fed via the connecting line 12 into an exhaust line 13 of the exhaust ports 4 of the remaining piston cylinder-units 2.

The exhaust ports 4 of the remaining piston-cylinder-units 2 (which are not fluidically connected to the intake system 5) are fluidically connected via an exhaust line 13 to the turbine 14 of the turbocharger unit 15.

The remining features of the embodiment of FIG. 2 essentially correspond to the embodiment of FIG. 1, wherein it can be seen that by use of a configuration as disclosed in FIG. 2 a high number of components can be reduced (e.g., a whole turbocharger unit 15), wherein by using a whole cylinder bank 7 for exhaust gas recirculation (e.g., in configurations combusting hydrogen) still the same delivery of air, exhaust and fuel mass can be obtained to the piston-cylinder units.

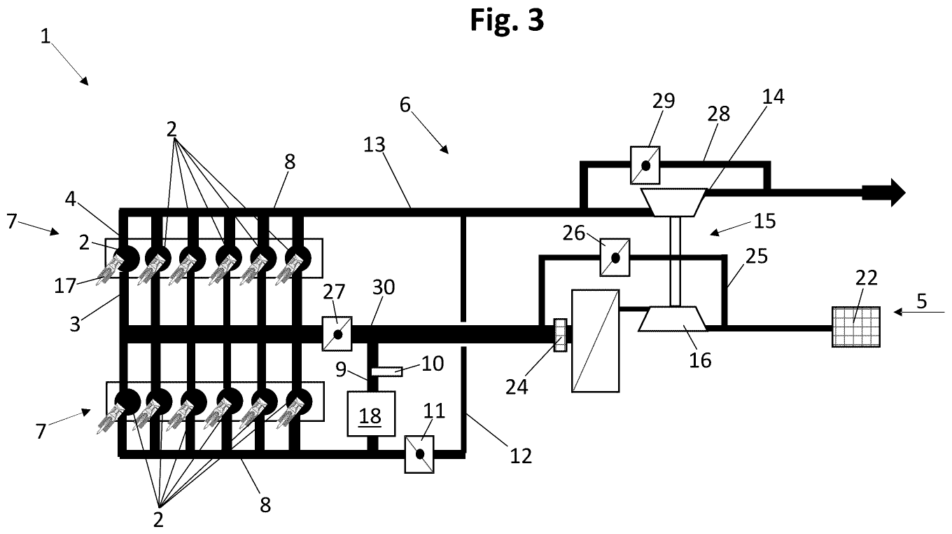

FIG. 3 discloses an embodiment of an internal combustion engine 1, wherein, in contrast to the state of the art, the exhaust ports 4 of at least two piston-cylinder-units 2 are directly fluidically connected to the intake system 5 to recirculate an exhaust gas into the combustion of the at least three piston-cylinder-units 2 and the exhaust system 6 is configured to entirely discharge exhaust gas from the remaining piston cylinder-units 2.

Essentially, the embodiment of FIG. 3 matches with the embodiment of FIG. 2, except for the fuel supply for the piston-cylinder units.

At the second embodiment shown by FIG. 3, a fuel injector 10 is provided at the exhaust gas recirculation line 9, wherein a fuel, preferably hydrogen, is supplied into the exhaust gas recirculation line 9 and therefore is being mixed with the exhaust gas before entering the intake manifold 30.

By injecting fuel for the combustion into the exhaust gas recirculation line 9 especially fuel having a high flammability (e.g., hydrogen) can be fed into the intake system 5 in a relatively stable way, as the enriched exhaust gas does not have a flammability (as the exhaust gas does not have or only a relatively low amount of hydrogen), wherein the risk of an unintentional combustion in the intake system 5 can be reduced.

The remaining characteristics of FIG. 3 essentially correspond with the characteristics disclosed by the embodiment shown by FIG. 2.

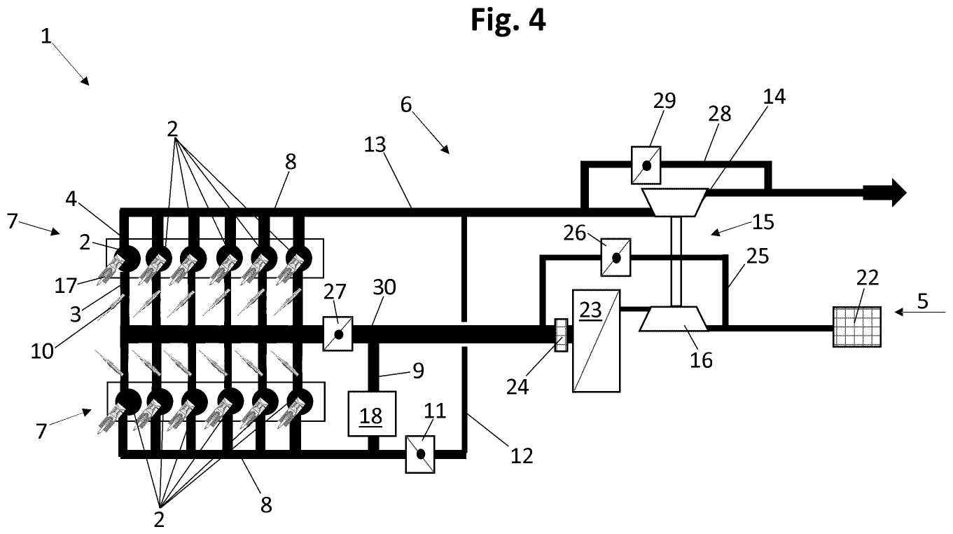

FIG. 4 discloses a further embodiment of an internal combustion engine 1, wherein, in contrast to the state of the art, the exhaust ports 4 of at least two piston-cylinder-units 2 are directly fluidically connected to the intake system 5 to recirculate an exhaust gas into the combustion of the at least three piston-cylinder-units 2 and the exhaust system 6 is configured to entirely discharge exhaust gas from the remaining piston cylinder-units 2.

This embodiment shown by FIG. 4 includes fuel injectors 10, preferably hydrogen port fuel injectors (PFI), arranged in each intake port 3 of each piston-cylinder unit 2, to mix the supplied compressed air provided via the central intake manifold with a fuel, wherein the piston-cylinder units 2 are provided by a pre-mixed air-fuel mixture.

The remaining characteristics of FIG. 4 essentially correspond with the characteristics disclosed by the embodiment shown by FIG. 2.

Furthermore, an embodiment combining at least two of the injection concepts of FIG. 2, FIG. 3 and/or FIG. 4 are quite conceivable, wherein an embodiment of an internal combustion engine having a fuel injector arranged in the exhaust gas recirculation line 9, in at least one piston-cylinder unit 2 and/or in at least one intake port 3 would be possible.

Furthermore, it would be quite conceivable to arrange at least one pressure transducer at the exhaust gas recirculation line 9.

### REFERENCE SIGNS

1 internal combustion engine
2 piston-cylinder unit
3 intake port
4 exhaust port
5 intake system
6 exhaust system
7 cylinder bank
8 exhaust manifold
9 exhaust gas recirculation line
10 fuel injector
11 exhaust gas recirculation valve
12 connecting line
13 exhaust line
14 turbine
15 turbocharger unit
16 compressor
17 pre-chamber
18 first exhaust gas cooler
19 second exhaust gas cooler
20 third exhaust gas cooler
21 drainage line
22 air filter
23 intercooler
24 drainage filter
25 intake bypass lines
26 compressor bypass valves
27 throttle valve
28 exhaust bypass line
29 turbine bypass valve
30 intake manifold

1. A system, comprising:
an internal combustion engine, comprising
at least three piston-cylinder-units configured to combust an air-fuel mixture in a combustion chamber, wherein each of the at least three piston-cylinder-units comprises an intake port and an exhaust port;
an intake system fluidically connected to each intake port of the at least three piston-cylinder-units, wherein the intake system is configured to supply air or air-fuel mixture; and
an exhaust system configured to discharge exhaust gases of combustion of the air-fuel mixture, wherein the exhaust ports of at least two piston-cylinder-units are fluidically connected to the intake system to recirculate an exhaust gas into the combustion chamber of the at least three piston-cylinder-units and the exhaust system is configured to entirely discharge exhaust gas from one or more remaining piston cylinder-units of the at least three piston-cylinder-units.

2. The system of claim 1, wherein the internal combustion engine comprises at least two cylinder banks, wherein the exhaust ports of all piston-cylinder-units of one cylinder bank are fluidically connected to the intake system.

3. The system of claim 2, wherein the exhaust ports of the piston-cylinder-units of each of the at least two cylinder bank are connected to an exhaust manifold, wherein in each exhaust manifold the exhaust gases of the respective cylinder bank of the corresponding piston-cylinder-units are merged.

4. The system of claim 3, wherein one of the exhaust manifolds of the cylinder banks is fluidically connected to the intake system to feed an entire exhaust gas of one cylinder bank to the intake system.

5. The system of claim 1, wherein a fluid connection between the exhaust ports and the intake system is provided by an exhaust gas recirculation line.

6. The system of claim 5, wherein at least one fuel injector, comprising a hydrogen injector, is coupled to the exhaust gas recirculation line.

7. The system of claim 5, wherein an exhaust gas recirculation valve is coupled to the exhaust gas recirculation line, wherein a controller is configured to control the exhaust gas recirculation valve to control an amount of exhaust gas fed into the intake system.

8. The system of claim 7, comprising a connecting line, wherein the exhaust gas recirculation valve is configured to control a surplus amount of exhaust gas via the connecting line into an exhaust line of the exhaust ports of the one or more remaining piston cylinder-units of the at least three piston-cylinder-units.

9. The system of claim 1, wherein the intake system comprises one central intake manifold fluidically connected via the intake ports to all piston-cylinder-units.

10. The system of claim 1, wherein intake system comprises an EGR-mixer configured to mix the air or the air-fuel mixture with the recirculated exhaust gas.

11. The system of claim 1, wherein the exhaust ports of the one or more remaining piston-cylinder-units of the at least three piston-cylinder-units are fluidically connected via an exhaust line to a turbine of a turbocharger unit.

12. The system of claim 1, wherein the intake system comprises a compressor of a turbocharger unit configured to charge the air or the air-fuel mixture being feed to the at least three piston-cylinder-units.

13. The system of claim 12, wherein, in a flow direction of the air or the air-fuel mixture, the compressor is arranged upstream of a fluid connection of the exhaust ports of the at least two piston-cylinder-units and the intake system.

14. The system of claim 1, wherein comprising a high pressure exhaust gas recirculation system coupled to the internal combustion engine.

15. The system of claim 1, wherein at least one fuel injector is arranged in each of the piston-cylinder-units, wherein an air-fuel mixture in the combustion chambers is provided by supplying air via the intake system and a fuel comprising hydrogen via the fuel injectors.

16. The system of claim 1, wherein the internal combustion engine is a stationary internal combustion engine drivingly coupled to a generator to generate electricity.

17. A system, comprising:
an internal combustion engine, comprising
a plurality of combustion chambers, wherein each combustion chamber has a piston configured to reciprocate within a cylinder;
an intake system coupled to each of the plurality of combustion chambers;
an exhaust system coupled to each of the plurality of combustion chambers, wherein the exhaust system is configured to:
discharge exhaust gas from at least one first combustion chamber of the plurality of combustion chambers; and
recirculate exhaust gas from at least one second combustion chamber of the plurality of combustion chambers into one or more of the plurality of combustion chambers via the intake system.

18. The system of claim 17, wherein the at least one first combustion chamber comprises a first plurality of combustion chambers of a first cylinder bank, and the at least one second combustion chamber comprises a second plurality of combustion chambers of a second cylinder bank.

19. A method, comprising:
discharging an exhaust gas from at least one first combustion chamber of a plurality of combustion chambers via an exhaust system of an internal combustion engine, wherein each combustion chamber has a piston configured to reciprocate within a cylinder; and
recirculating the exhaust gas from at least one second combustion chamber of the plurality of combustion chambers into one or more of the plurality of combustion chambers via an intake system.

20. The method of claim 19, wherein the at least one first combustion chamber comprises a first plurality of combustion chambers of a first cylinder bank, and the at least one second combustion chamber comprises a second plurality of combustion chambers of a second cylinder bank.
